(19) United States
(12) Patent Application Publication
(10) Pub. No.: US 2025/0039357 A1
(43) Pub. Date: Jan. 30, 2025

(54) CHROMA PREDICTION FOR VIDEO ENCODING AND DECODING BASED ON TEMPLATE MATCHING

(71) Applicant: InterDigital CE Patent Holdings, SAS, Paris (FR)

(72) Inventors: Karam Naser, Mouaze (FR); Saurabh Puri, Saint-Lazare (CA); Tangi Poirier, Thorigne-Fouillard (FR); Gaëlle Martin-Cocher, Toronto (CA); Antoine Robert, Mezieres sur Couesnon (FR); Thierry Dumas, Rennes (FR); Franck Galpin, Thorigne-Fouillard (FR)

(21) Appl. No.: 18/689,407

(22) PCT Filed: Aug. 29, 2022
(86) PCT No.: PCT/EP2022/073903

§ 371 Date: Mar. 5, 2024

(30) Foreign Application Priority Data
Sep. 7, 2021 (EP) 21306219.3
Jul. 8, 2022 (EP) 22306033.6

(51) Int. Cl. H04N 19/105; H04N 19/176; H04N 19/186

(52) U.S. Cl. CPC H04N 19/105; H04N 19/176; H04N 19/186

(57) ABSTRACT

A method and apparatus for processing video information comprises determining a chroma component prediction for a current block based on samples of a selected block, the block being selected in an area of decoded picture information based on a template matching process comprising a comparison of a template associated with the current block to at least one other template associated with at least one other block in an area of decoded picture information.

### TECHNICAL FIELD

The disclosure is in the field of video compression, and at least one embodiment relates more specifically to prediction of chroma components based on template matching.

### BACKGROUND ART

To achieve high compression efficiency, image and video coding schemes usually employ prediction and transform to leverage spatial and temporal redundancy in the video content. Generally, intra or inter prediction is used to exploit the intra or inter frame correlation, then the differences between the original picture block and the predicted picture block, often denoted as prediction errors or prediction residuals, are transformed, quantized and entropy coded. To reconstruct the video, the compressed data is decoded by inverse processes corresponding to the entropy coding, quantization, transform, and prediction.

### SUMMARY

In general, at least one example of an embodiment involves a method or an apparatus for video encoding or decoding comprising providing an intra prediction processing mode employing template matching prediction for luma and for chroma components of an image.

A first aspect is directed to a method comprising, for a current block of picture information comprising a luma block and at least one chroma block, selecting a block in an area of partially decoded picture information based on a template matching process comprising a comparison of a template associated with the current block to at least one other template associated with at least one other block in an area of decoded picture information and determining a prediction for at least one chroma component of the current block based on samples of the selected block.

A second aspect is directed to an apparatus comprising at least one processor configured to, for a current block of picture information comprising a luma block and at least one chroma block, select a block in an area of partially decoded picture information based on a template matching process comprising a comparison of a template associated with the current block to at least one other template associated with at least one other block in an area of decoded picture information and determine a prediction for at least one chroma component of the current block based on samples of the selected block.

In variant embodiments of first and second embodiment, the template matching process is applied independently to the luma, Cb chroma and Cr chroma components, respectively in a partially decoded luma picture information, in a partially decoded Cb chroma picture information or in a partially decoded Cr chroma picture information. In variant embodiments of first and second embodiment, the template matching process is applied only for the luma components and further comprises determining a displacement vector based on the distance between the selected luma block and the current luma block, selecting a Cb chroma block in an area of decoded Cb chroma picture information based on the displacement vector, selecting a Cr chroma block in an area of decoded Cr chroma picture information based on the displacement vector and determining a prediction block for the current block based on samples of the selected luma, Cb chroma and Cr chroma blocks.

In variant embodiments of first and second embodiment, the template matching process is applied only for the luma components and further comprises determining a displacement vector based on the distance between the selected luma block and the current luma block, determining Cb and Cr chroma refinement areas respectively in decoded Cb and Cr chroma picture information based on the displacement vector, selecting a Cb chroma block by applying a template matching process in the Cb chroma refinement area, selecting a Cr chroma block by applying a template matching prediction in the Cr chroma refinement area, determining a prediction block for the current block based on samples of the selected luma, Cb chroma and Cr chroma blocks.

Variant embodiments of first and second embodiment further comprises decoding the current block based on the prediction block or encoding the current block based on the prediction block, the encoding comprising a first information signaling the use of template matching prediction process for the current luma block and a second information signaling the use of template matching prediction process for the current chroma blocks.

A third aspect is directed to a non-transitory computer readable medium containing data content generated according to any of the described embodiments or variants related to the second aspect.

A fourth aspect is directed to non-transitory computer readable medium containing comprising instructions which, when the program is executed by a computer, cause the computer to carry out any of the described embodiments or variants related to the first aspect.

A fifth aspect is directed to a computer program product comprising instructions which, when the program is executed by a computer, cause the computer to carry out any of the described embodiments or variants related to the first aspect.

The above presents a simplified summary of the subject matter in order to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of a video encoder according to an embodiment.

FIG. 2 illustrates a block diagram of a video decoder according to an embodiment.

FIG. 3 illustrates a block diagram of an example of a system in which various aspects and embodiments are implemented.

FIG. 4A illustrates the principles of template matching prediction for luma components.

FIG. 4B illustrates the principles of intra prediction using intra block copy.

FIG. 4C illustrates the allowed search range for intra block copy for a current block.

FIGS. 5A and 5B illustrate the principles of template matching prediction for chroma components according to at least one embodiment.

FIG. 6A illustrates a flowchart of an example of encoding process using chroma template matching prediction according to at least one embodiment. FIG. 6B illustrates a flowchart of an example of decoding process using chroma template matching prediction according to at least one embodiment.

FIGS. 7A, 7B and 7C illustrate the principles of exploiting results of the luma template matching prediction for the chroma prediction according to at least one embodiment.

FIG. 8A illustrates a flowchart of an example of encoding process exploiting results of the luma template matching prediction for the chroma prediction according to at least one embodiment. FIG. 8B illustrates a flowchart of an example of decoding process exploiting results of the luma template matching prediction for the chroma prediction according to at least one embodiment.

FIGS. 9A, 9B and 9C illustrate the principles of chroma template matching prediction in a refined area based on results of the luma template matching prediction according to at least one embodiment.

FIG. 10A illustrates a flowchart of an example of encoding using chroma template matching prediction in a refined area based on results of the luma template matching prediction according to at least one embodiment. FIG. 10B illustrates a flowchart of an example of decoding using chroma template matching prediction in a refined area based on results of the luma template matching prediction according to at least one embodiment.

FIG. 11 illustrates a table of an example of syntax signaling of template matching prediction according to at least one embodiment.

FIG. 12 illustrates a table of an example of syntax signaling of luma and chroma template matching prediction according to at least one embodiment.

FIG. 13 illustrates a table of a second example of syntax signaling of luma and chroma template matching prediction according to at least one embodiment.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

As will be described in more detail below, a video codec can involve determining a prediction block for a current block based on samples of a selected block, the block being selected in an area of decoded picture information based on a template matching process comprising a comparison of a template associated with the current block to at least one other template associated with at least one other block in an area of decoded picture information. Encoding method, decoding method, encoding apparatus, decoding apparatus based on this principle are described.

Moreover, the present aspects, although describing principles related to particular drafts of VVC (Versatile Video Coding) or to HEVC (High Efficiency Video Coding) specifications, are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

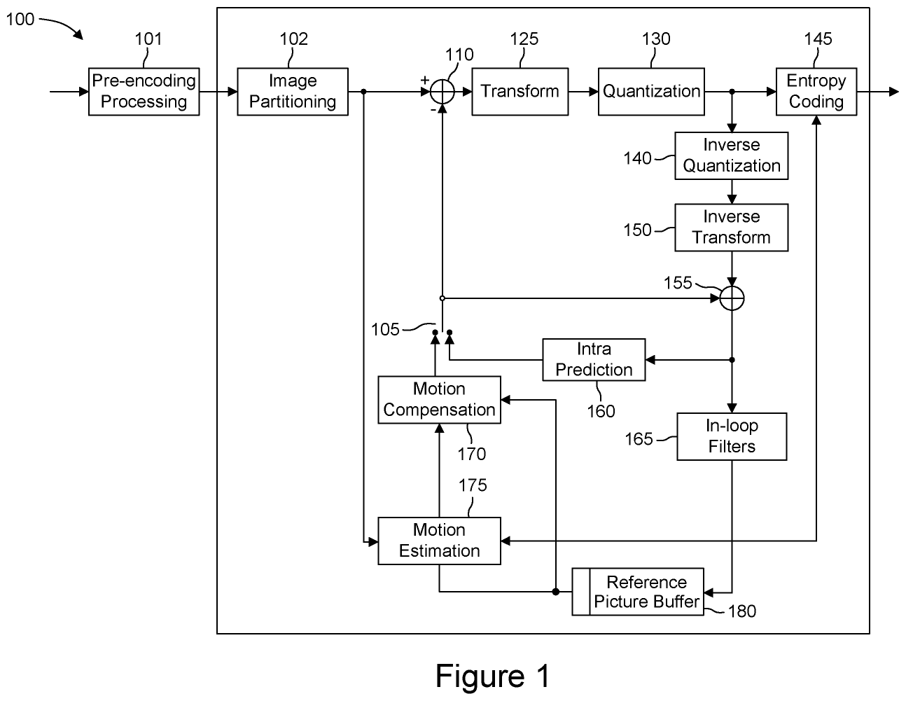

FIG. 1 illustrates a block diagram of a video encoder according to an embodiment. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset), Adaptive Loop-Filter (ALF) filtering to reduce encoding artifacts. The filtered image is stored at a reference picture buffer (180).

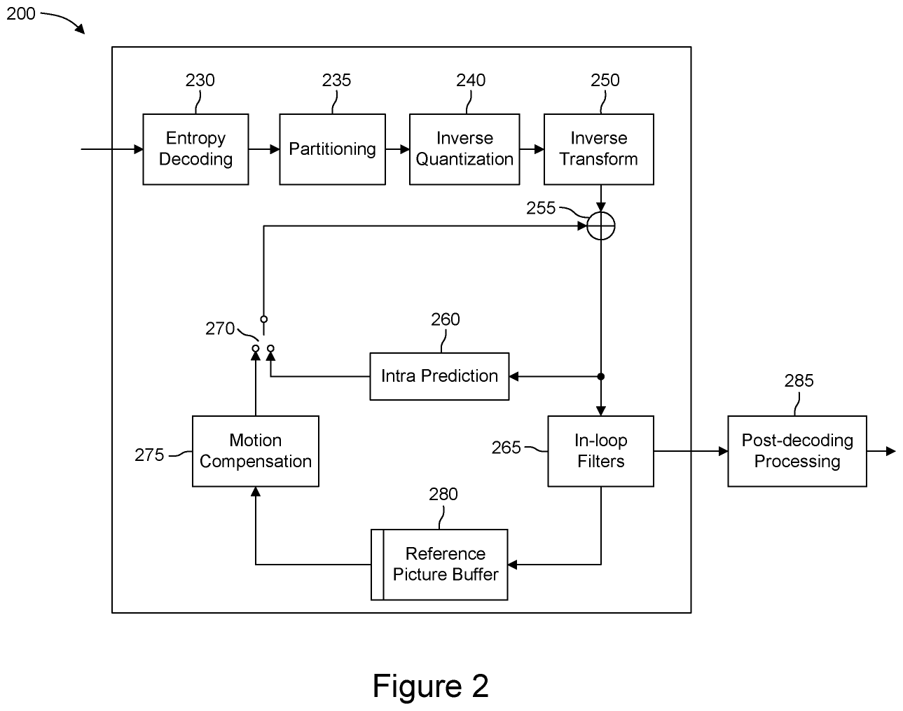

FIG. 2 illustrates a block diagram of a video decoder according to an embodiment. In the decoder 200, a bitstream is decoded by the decoder elements as described below. Video decoder 200 generally performs a decoding pass reciprocal to the encoding pass. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

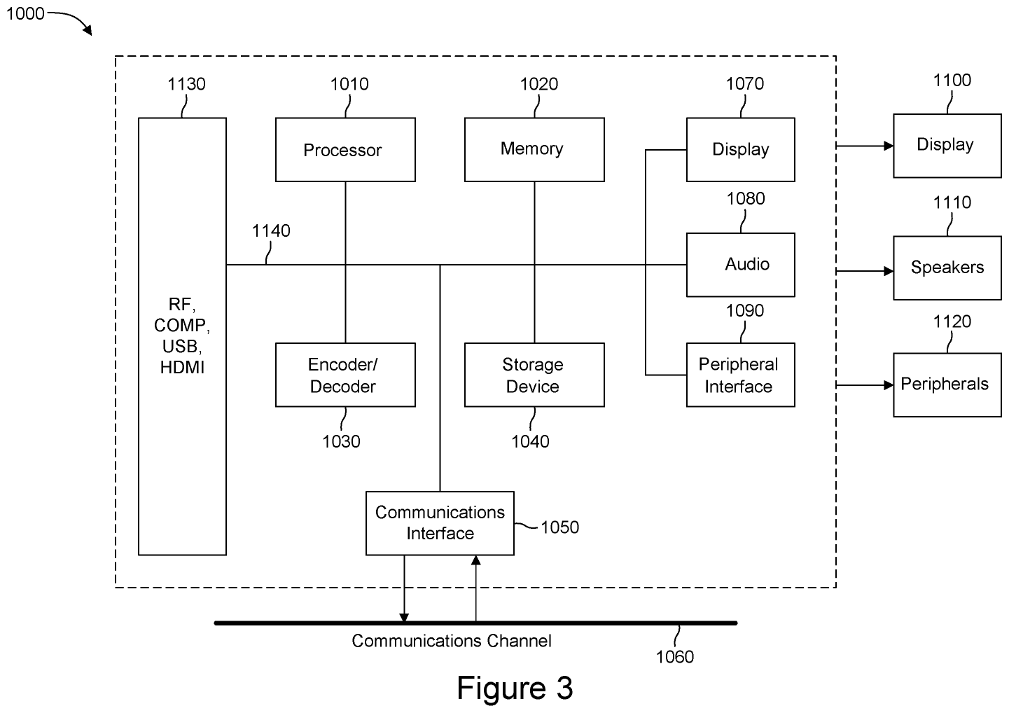

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. The processor 1010 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High-Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other devices. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

The technical field of the invention is related to the intra prediction stage of a video compression scheme and more particularly on how to perform intra prediction for chroma components based on template matching.

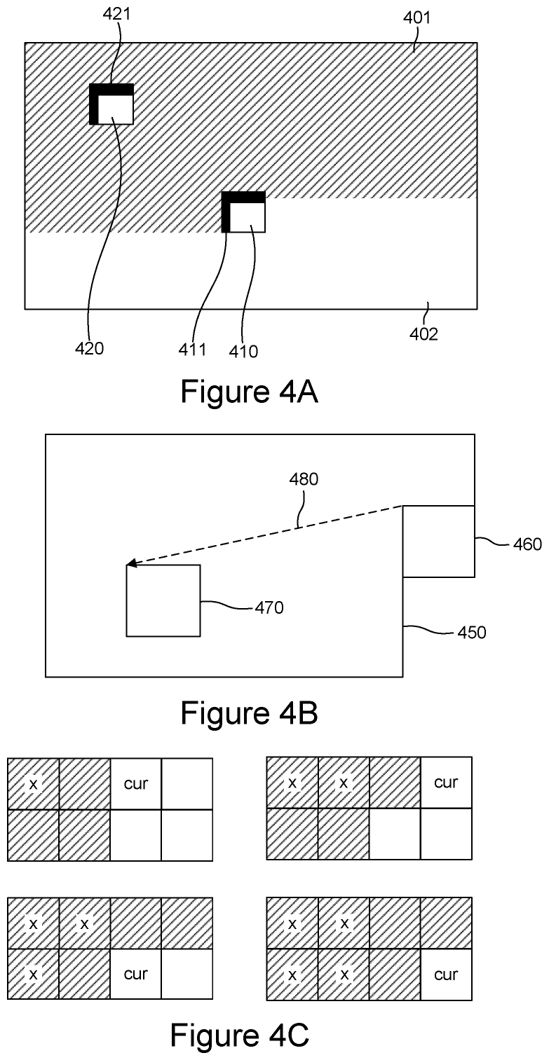

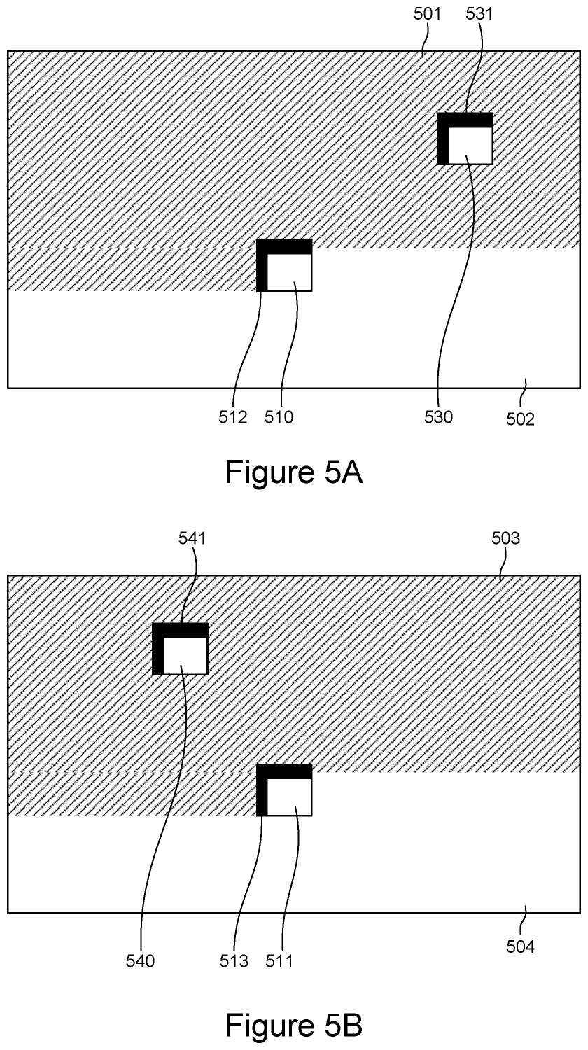

FIG. 4A illustrates the principles of template matching prediction for luma components. The process is similar on both sides. In other words, it is implemented both by the encoder device and by the decoder device. In the figure, the area 401 represents the luma blocks already encoded/reconstructed while the area 402 represents the luma blocks still to encode/reconstruct. The area 401 is conventionally identified as the reconstructed picture buffer (or information) at the encoder side and the decoded picture buffer (or information) on the decoder side. When template matching prediction (TMP) is used, the device determines, for a current luma block 410, a set of pixels 411 forming a neighborhood of the current luma block. This set of pixels, conventionally taking the form of an L-shape, is named template. Various sizes (for example one, two or four pixels wide) and shapes (for example: rows above the block or columns at the left of the bock or both the rows above the block and the columns at the left of the bock) may be used for TMP but still based on the same principle. A search within the encoded/reconstructed area 401 is performed by the device to find a template 421 that is the most similar to the template 411. The search uses known techniques to determine the area of pixels with minimal difference compared to the template 411. For that purpose, the sum of absolute differences (SAD) between samples of the blocks or other conventional techniques may be used. The block 420 corresponding to the best matching template 421 is then identified and the samples of this block are used for the prediction of the current block. At the encoding, the template of the current block is formed, and the encoder searches within the reconstructed area the most similar template. The block associated with the similar template is used as prediction block. The residual is computed by subtracting the prediction block from the current block and the subsequently transformed, quantized and entropy-encoded into the bitstream. The encoder also signals the usage of that mode by a CU level flag. At the decoding, if the cu level flag indicates the usage of TMP, the inverse TMP process is performed. First, the reference template around the current block is formed, and the decoder searches for the best matching template. The corresponding block is used as prediction block, where it is added to the residual signal obtained by inverse quantization and inverse transform.

FIG. 4B illustrates the principles of intra prediction using intra block copy. Intra-block copy (IBC) is a tool particularly adapted to so-called screen content coding, i.e., non-natural computer-generated sequences that includes large identical areas such as user interface screens. IBC is based on finding a matching reference block within a reconstructed area 450 of the current frame. At the encoding, when a match is found between the current block 460 and a reconstructed block 470, the so-called block vector 480 between the current block and the matching block, analogous to a motion vector, is selected for reconstructing the block and is signaled to the decoder to perform block compensation, analogous to motion compensation. In one example of IBC mode, the current block 460 is then reconstructed by copying the samples of the block 411.

FIG. 4C illustrates the allowed search range for intra block copy for a current block. Indeed, in an example implementation using VVC, the search range is extended to pixels beyond the current coding tree unit (CTU), to the left CTU depending on the block position. However, some block positions are not allowed and cannot be used for IBC. In this figure, four different positions of the current block are shown. The current block within the current CTU is identified by “curr”, the white blocks are the block still to be reconstructed, the diagonal hatched blocks are the blocks already reconstructed, while the not-allowed blocks are identified by a “x” marking.

IBC AMVP mode proposes to use conventional AMVP mode inter-prediction motion related techniques restricted to the reconstructed samples. More particularly, at encoder, the IBC AMVP mode selects several already used input vectors as predictors (or zeros) and performs, for each, a process similar to a motion estimation to find within a window in the reconstructed samples the block that is the most similar to the current block. A RDO process allows then selecting the best predictor. The index of this best predictor and the vector differential as the difference between the estimated and the input vector are signalled. At decoder, the IBC AMVP mode selects the same input vectors. It adds the transmitted vector difference to the input vector indicated by the signalled index and reconstructs the current block by using the resulting vector.

IBC merge mode proposes to use conventional merge mode inter-prediction motion related techniques restricted to the reconstructed samples. More particularly, at encoder, the IBC merge mode selects several already used input vectors as predictors. A RDO process allows then selecting the best predictor. The index of this best predictor is signalled. At decoder, the IBC merge mode selects the same input vectors and uses the input vector indicated by the transmitted index to reconstruct the current block.

Template Matching can be used in IBC for both IBC merge mode (IBC-TM) and IBC AMVP mode (IBC-TM-AMVP).

The IBC-TM merge list is modified compared to the one used by regular IBC merge mode such that the candidates are selected according to a pruning method with a motion distance between the candidates as in the regular TM merge mode. In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 4C. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

A combination of intra template matching and IBC can be done. Basically, the intra template matching block vector (the displacement vector between the current block and the prediction block) can be put in the IBC candidate list of block vector predictors. However, this could be limited to IntraTMP for luma component.

FIGS. 5A and 5B illustrate the principles of template matching prediction for chroma components according to at least one embodiment. FIG. 5A relates to the Cb chroma component while FIG. 5B relates to the Cr chroma component. The process is independent for each chroma component. It applies the same principles than the template matching prediction for luma described in FIG. 4 but in each of the chroma component plane.

In FIG. 5A, the area 501 represents the Cb chroma blocks already encoded/reconstructed while the area 502 represents the Cb chroma blocks still to encode/reconstruct. When template matching prediction is used, the device determines, for a current Cb chroma block 510, a set of pixels 512 forming a template in the neighborhood of the current Cb chroma block. A search within the encoded/reconstructed area 501 is performed by the device to find a template 531 that is the most similar to the template 512. Similar to luma, the search uses known techniques to determine the area of pixels with minimal difference compared to the template, for example using the sum of absolute differences (SAD) between samples of the blocks. The Cb chroma block 530 corresponding to the best matching template 531 is then identified and the samples of this block are used for the prediction of the Cb chroma current block similar to the luma.

Similarly, in FIG. 5B, the area 503 represents the Cr chroma blocks already encoded/reconstructed while the area 504 represents the Cr chroma blocks still to encode/reconstruct. When template matching prediction is used, the device determines, for a current Cr chroma block 511, a set of pixels 513 forming a template in the neighborhood of the current Cr chroma block. A search within the encoded/reconstructed area 503 is performed by the device to find a template 541 that is the most similar to the template 513. Similar to luma, the search uses known techniques to determine the area of pixels with minimal difference compared to the template, for example using the sum of absolute differences (SAD). The Cr chroma block 540 corresponding to the best matching template 541 is then identified and the samples of this block are used for the prediction of the Cr chroma current block similar to the luma.

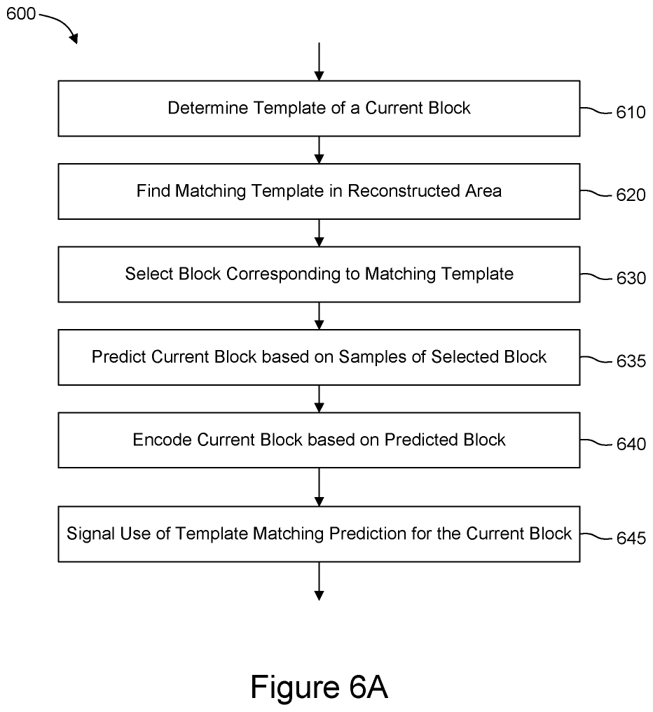

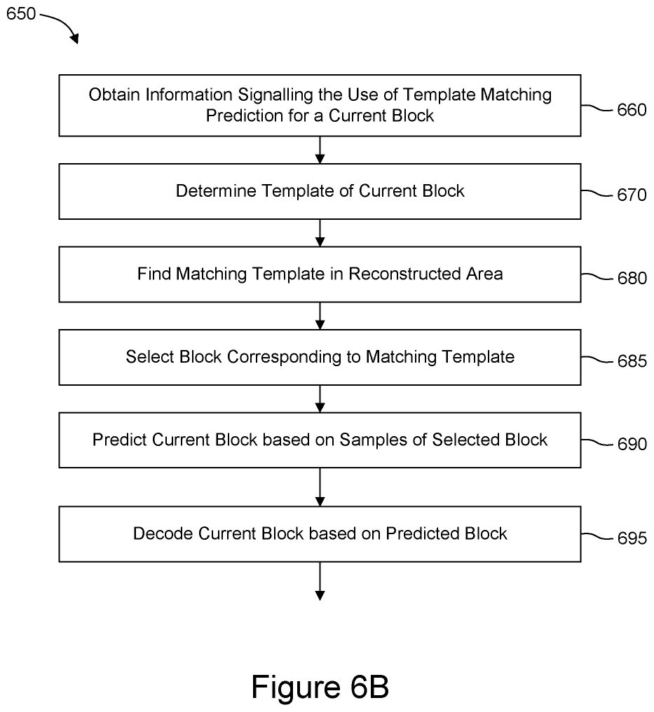

FIG. 6A illustrates a flowchart of an example of encoding process using chroma template matching prediction according to at least one embodiment. This encoding process 600 applies to both the Cb and the Cr chroma components and is implemented for example by an encoder 100 of FIG. 1 in a device 1000 of FIG. 3. For a current chroma component block, in step 610, the device determines a template of neighbouring samples such as the template 512 of FIG. 5A or the template 513 of FIG. 5B. In step 620, the device finds a best matching template in the reconstructed area of the chroma plane, such as the template 531 of FIG. 5A or the template 541 of FIG. 5B and selects the chroma block corresponding to the best matching template in step 630. The samples of the selected chroma block are then used in step 635 to predict the current chroma block. In step 640, the current block is then conventionally encoded based on the predicted block and the use of the chroma template matching prediction is signaled for the current chroma block in step 645.

FIG. 6B illustrates a flowchart of an example of decoding process using chroma template matching prediction according to at least one embodiment. This decoding process 650 applies to both the Cb and the Cr chroma components and is implemented for example by a decoder 200 of FIG. 2 in a device 1000 of FIG. 3. In step 660, the device obtains information signaling the use of chroma template matching prediction for the current chroma block. In this case, in step 670, the device determines a template of neighbouring samples for the current chroma component block, such as the template 512 of FIG. 5A or the template 513 of FIG. 5B. In step 680, the device finds a best matching template in the reconstructed area of the chroma plane, such as the template 531 of FIG. 5A or the template 541 of FIG. 5B and selects the chroma block corresponding to the best matching template in step 685. The samples of the selected chroma block are then used in step 690 to predict the current chroma block. In step 695, the current block is then conventionally decoded based on the predicted block.

The application of the TMP process to the chroma components provides coding gains, at the cost of an increased complexity. Indeed, the TMP process is repeated three times: for the luma components and for each of the two chroma components. Therefore, the following embodiments aim at exploiting the correlation between luma and chroma components by reusing results of the luma TMP process to reduce the complexity.

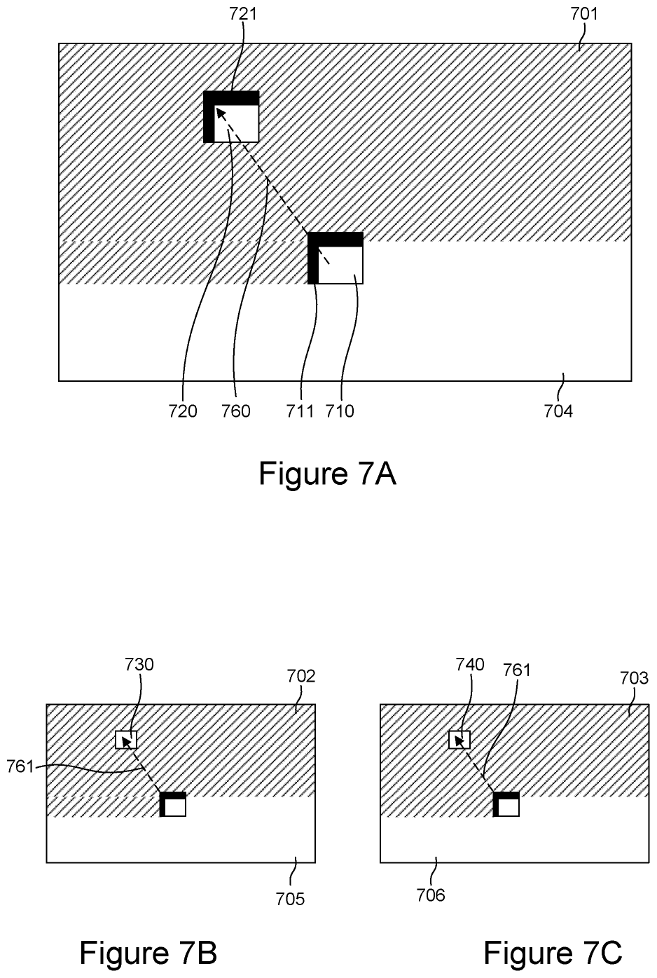

FIGS. 7A, 7B and 7C illustrate the principles of exploiting results of the luma template matching prediction for the chroma prediction according to at least one embodiment. The process is similar on both sides. In other words, it is implemented both by the encoder device and by the decoder device. In these figures, the area 701, 702, 703 respectively represent the luma blocks, the Cb chroma components and the Cr chroma components already encoded/reconstructed, while the areas 704, 705, 706 respectively represent the blocks still to encode/reconstruct for the luma, the Cb chroma and the Cr chroma. When template matching prediction (TMP) is used, the device determines, for a current luma block 710, a set of pixels forming the luma template 711 in the neighborhood of the current luma block. A search within the encoded/reconstructed luma area 701 is performed by the device to find a template 721 that is the most similar to the template 711, using for example the sum of absolute differences or other techniques to measure distance or similarity. The luma block 720 corresponding to the best matching luma template 721 is then identified and the samples of this block are used for the prediction of the luma. The luma displacement vector 760 between the current block 710 and the best matching block 720 is determined. For the chroma, a chroma displacement vector 761 corresponding to the luma displacement vector 760 is determined, taking into account the size differences for luma and chroma blocks. In other words, the chroma displacement vector 761 is determined according to the subsampling conventionally performed between luma and chroma components. The subsampling may apply to the horizontal and vertical direction. Corresponding Cb and Cr chroma blocks 730 and 740 are then determined based on the chroma displacement vector 761 and the samples of these blocks are then used for the prediction.

This embodiment is more efficient than the embodiments of FIGS. 5A and 5B since is reuses the displacement vector to determine the best matching blocks, thus exploiting the correlation between luma and chroma components.

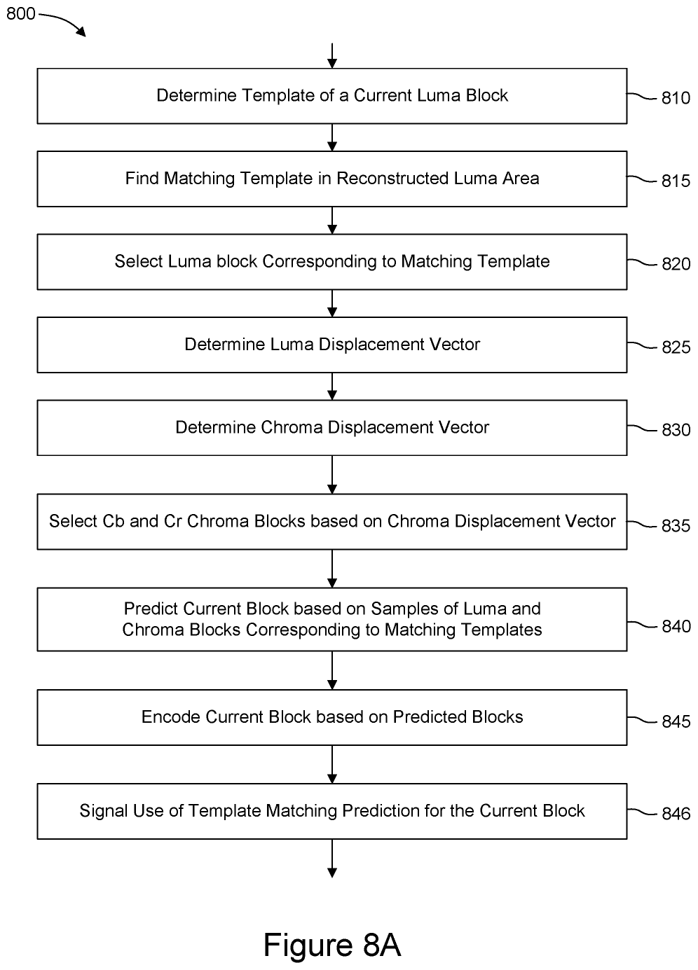

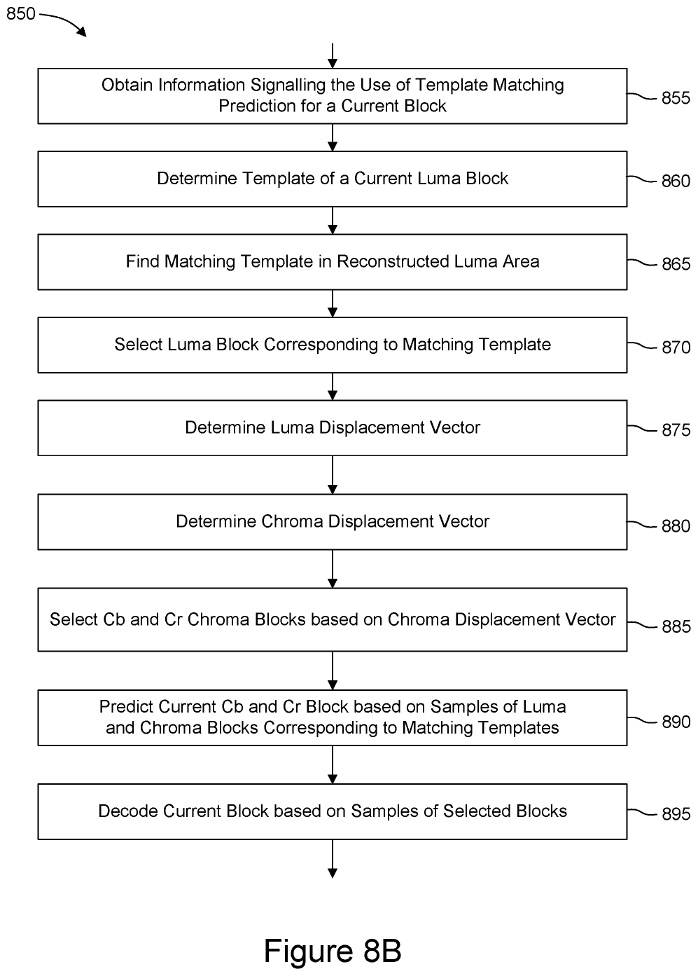

FIG. 8A illustrates a flowchart of an example of encoding process exploiting results of the luma template matching prediction for the chroma prediction according to at least one embodiment. This encoding process 800 is implemented for example by an encoder 100 of FIG. 1 in a device 1000 of FIG. 3. For a current luma block, in step 810, the device determines a template of neighbouring samples such as the template 711 of FIG. 7A. In step 815, the device finds a best matching template in the reconstructed area of the luma plane, such as the template 721 of FIG. 7A and selects the luma block corresponding to this best matching template in step 820. In step 825, a luma displacement vector between the current block and the best matching block is determined and a corresponding chroma displacement vector is determined in step 830, taking into account the size differences for luma and chroma blocks (i.e., chroma subsampling). In step 835, the device respectively selects the Cb and Cr chroma blocks in the reconstructed Cb and Cr chroma planes according to the chroma displacement. The samples of the selected luma and chroma blocks are then used in step 840 to predict the current luma and chroma blocks. In step 845, the current block is then conventionally encoded based on the predicted blocks and the use of the template matching prediction is signaled for the current chroma block in step 846.

FIG. 8B illustrates a flowchart of an example of decoding process exploiting results of the luma template matching prediction for the chroma prediction according to at least one embodiment. This decoding process 850 is implemented for example by an encoder 100 of FIG. 1 in a device 1000 of FIG. 3. In step 855, the device obtains information signaling the use of template matching prediction for the current block. In this case, in step 860, the device determines a template of neighbouring samples such as the template 711 of FIG. 7A. In step 865, the device finds a best matching template in the reconstructed area of the luma plane, such as the template 721 of FIG. 7A and selects the luma block corresponding to this best matching template in step 870. In step 875, a luma displacement vector between the current block and the best matching block is determined and a corresponding chroma displacement vector is determined in step 880, taking into account the size differences for luma and chroma blocks (i.e., chroma subsampling). In step 885, the device respectively selects the Cb and Cr chroma blocks in the reconstructed Cb and Cr chroma planes according to the chroma displacement. The samples of the selected luma and chroma blocks are then used in step 890 to predict the current luma and chroma blocks. In step 895, the current block is then conventionally decoded (reconstructed) based on the predicted blocks.

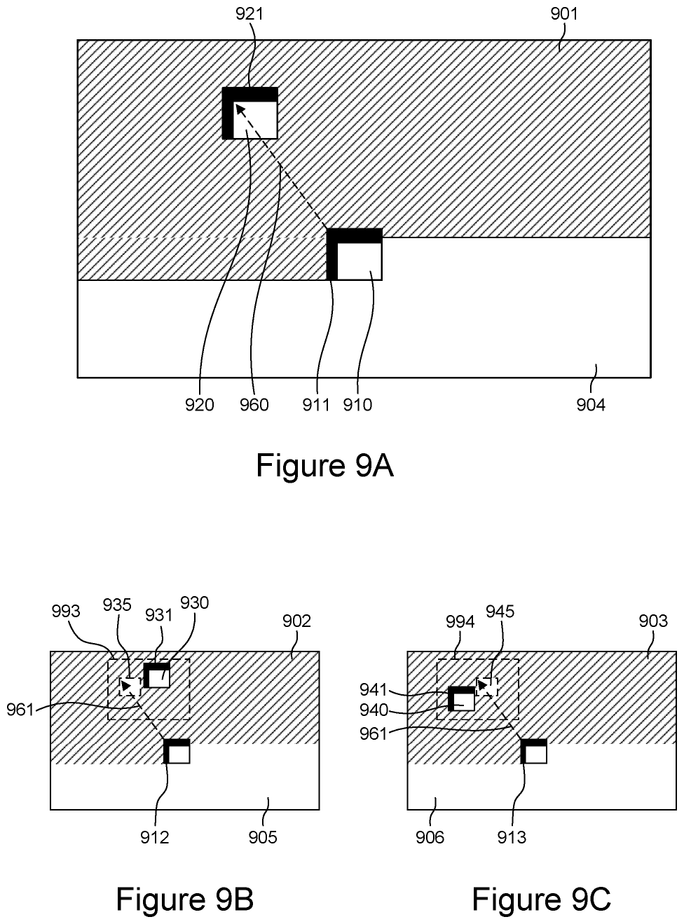

FIGS. 9A, 9B and 9C illustrate the principles of chroma template matching prediction in a refined area based on results of the luma template matching prediction according to at least one embodiment. The process is similar on both sides. In other words, it is implemented both by the encoder device and by the decoder device. In these figures, the area 901, 902, 903 respectively represent the luma blocks, the Cb chroma components and the Cr chroma components already encoded/reconstructed, while the areas 904, 905, 906 respectively represent the blocks still to encode/reconstruct for respectively the luma, the Cb chroma and the Cr chroma. When template matching prediction is used, the device determines, for a current luma block 910, a set of pixels 911 forming the luma template in the neighborhood of the current luma block. A search within the encoded/reconstructed luma area 901 is performed by the device to find a template 921 that is the most similar to the luma template 911, using for example the sum of absolute differences or other techniques to measure distance or similarity. The luma block 920 corresponding to the best matching luma template 921 is then identified and the samples of this block are used for the prediction/reconstruction of the luma. The luma displacement vector 960 between the current luma block 910 and the best matching luma block 920 is determined. For the chroma, a chroma displacement vector 961 corresponding to the luma displacement vector 960 is determined, taking into account the size differences for luma and chroma blocks. In other words, the chroma displacement vector 961 is determined according to the subsampling conventionally performed between luma and chroma components. The subsampling may apply to the horizontal and vertical direction. Then, for the Cb chroma plane, a refinement area 993 around the block 935 corresponding to the chroma displacement is determined. A Cb chroma template 912 corresponding to the surrounding pixels is determined and a search within the refinement area 993 of the Cb chroma plane is performed by the device to find a template 931 that is the most similar to the Cb chroma template 912. The corresponding Cb chroma block 930 is selected. The same process applies for the Cr chroma, within the refinement area 994 based on the Cr chroma template 913 to find the best matching Cr template 941 and select the corresponding Cr chroma block 940. Samples of the selected Cb and Cr block are then used for the prediction or reconstruction of the chroma.

This embodiment is particularly interesting for dual tree coding, where luma and chroma use different coding trees. It allows to perform a template matching for the chroma in a reduced area of refinement, taking into account small changes that may occur between luma and chroma components and thus improve the quality with regards to the FIGS. 7A, 7B, 7C without the cost of a full search as in FIGS. 5A, 5B.

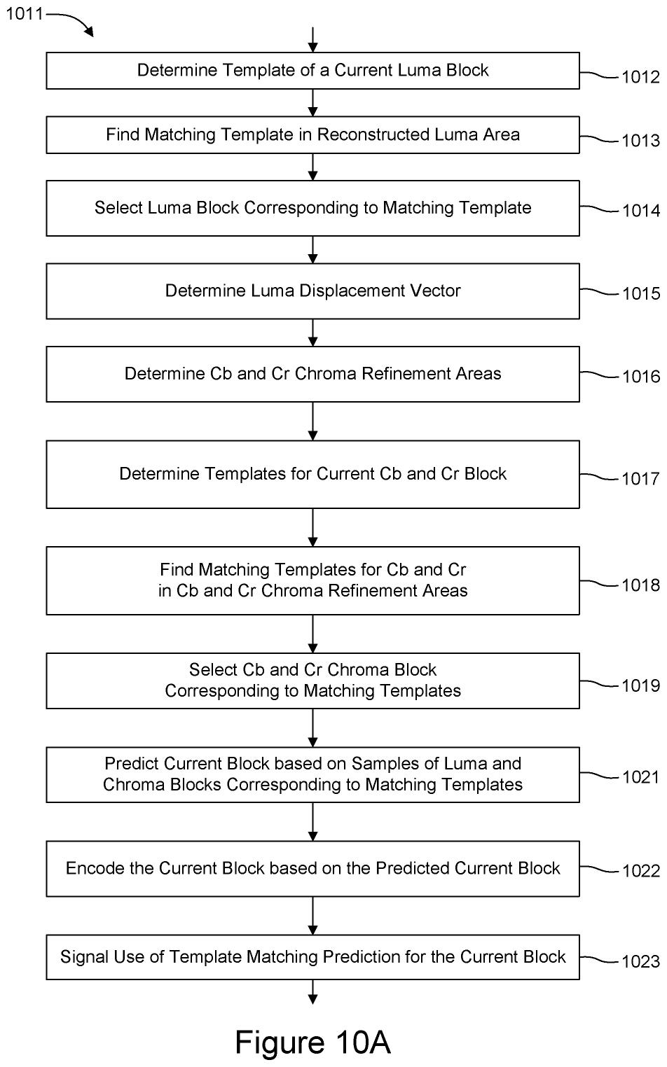

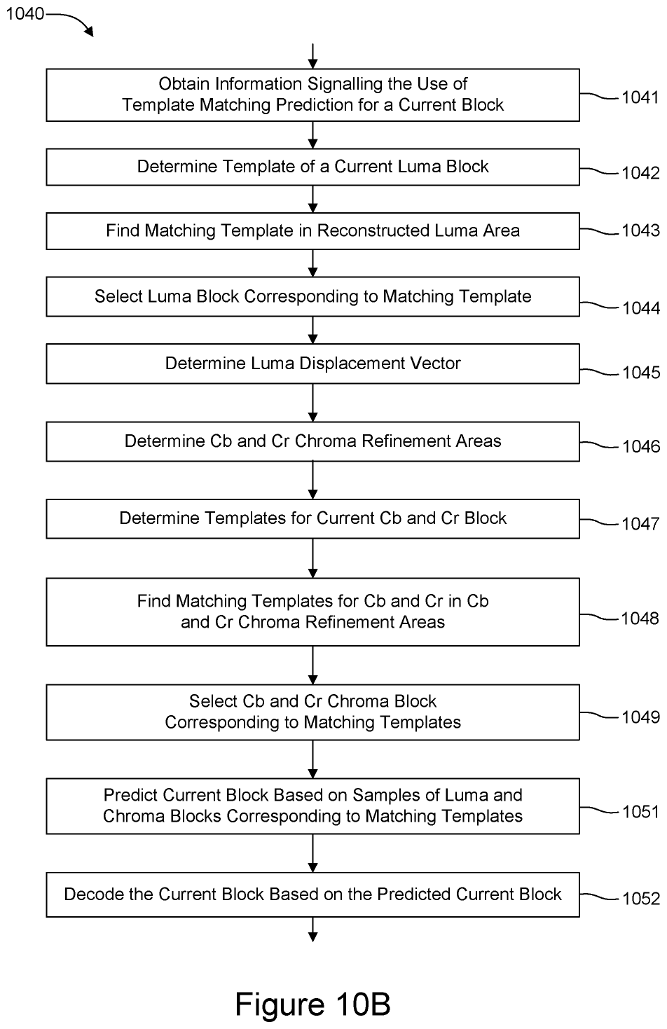

FIG. 10A illustrates a flowchart of an example of encoding using chroma template matching prediction in a refined area based on results of the luma template matching prediction according to at least one embodiment. This encoding process 1011 is implemented for example by an encoder 100 of FIG. 1 in a device 1000 of FIG. 3. For a current luma block, in step 1012, the device determines a template of neighbouring samples such as the template 911 of FIG. 9A. In step 1013, the device finds a best matching template in the reconstructed area of the luma plane, such as the template 921 of FIG. 9A and selects the luma block corresponding to this best matching template in step 1014. In step 1015, a luma displacement vector between the current luma block and the best matching luma block is determined and corresponding Cb and Cr chroma refinement areas are determined in step 1016, taking into account the size differences for luma and chroma blocks (i.e., chroma subsampling). Corresponding Cb and Cr chroma templates are determined in step 1017. In step 1018, the device respectively finds the best matching Cb and Cr templates in the refinement areas of the reconstructed areas of the Cb and Cr chroma planes, such as the template 931 of FIG. 9B for Cb and template 941 of FIG. 9C for Cr. In step 1019, the device respectively selects the Cb and Cr chroma blocks in the reconstructed Cb and Cr chroma planes according to the best matching Cb and Cr chroma templates. The samples of the selected luma and chroma blocks are then used in step 1021 to predict the current luma and chroma blocks that are then encoded based on the prediction in step 1022. In step 1023, the use of the template matching prediction is signalled for the current block.

FIG. 10B illustrates a flowchart of an example of decoding using chroma template matching prediction in a refined area based on results of the luma template matching prediction according to at least one embodiment. This decoding process 1040 is implemented for example by a decoder 200 of FIG. 2 in a device 1000 of FIG. 3.

In step 1041, the device obtains information signaling the use of template matching prediction for the current block. In this case, in step 1042, the device determines for a current luma block a template of neighbouring samples such as the template 911 of FIG. 9A. In step 1043, the device finds a best matching template in the reconstructed area of the luma plane, such as the template 921 of FIG. 9A and selects the luma block corresponding to this best matching template in step 1044. In step 1045, a luma displacement vector between the current luma block and the best matching luma block is determined and corresponding Cb and Cr chroma refinement areas are determined in step 1046, taking into account the size differences for luma and chroma blocks (i.e., chroma subsampling). Corresponding Cb and Cr chroma templates are determined in step 1047. In step 1048, the device respectively finds the best matching Cb and Cr templates in the refinement areas of the reconstructed areas of the Cb and Cr chroma planes, such as the template 931 of FIG. 9B for Cb and template 941 of FIG. 9C for Cr. In step 1049, the device respectively selects the Cb and Cr chroma blocks in the reconstructed Cb and Cr chroma planes according to the best matching Cb and Cr chroma templates. The samples of the selected luma and chroma blocks are then used in step 1051 to predict the current luma and chroma blocks that are then decoded (reconstructed) based on the predicted blocks in step 1052.

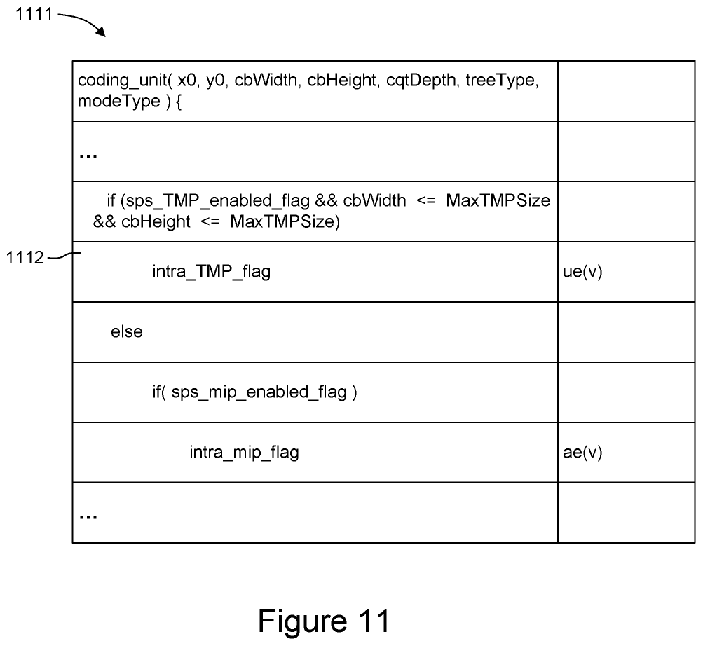

FIG. 11 illustrates a table of an example of syntax signaling of template matching prediction according to at least one embodiment. The table 1111 only shows a subset of the conventional syntax required to carry the information from an encoder to a decoder, allowing the decoder to reconstruct the original image or video. It shows particularly the “intra_TMP_flag” 1112 that is positioned at the coding unit level. When this flag is true, template matching prediction is to be performed for the current coding unit.

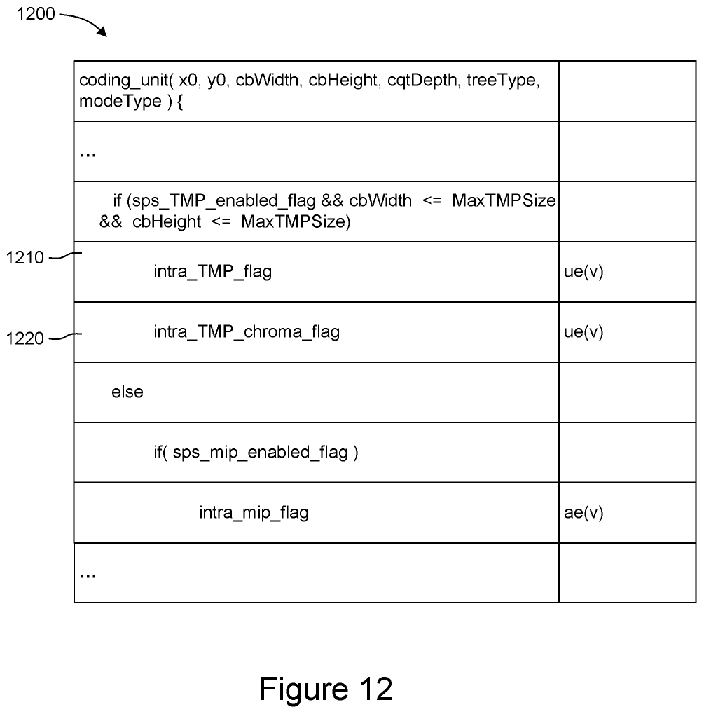

FIG. 12 illustrates a table of an example of syntax signaling of luma and chroma template matching prediction according to at least one embodiment. The table 1200 only shows a subset of the conventional syntax required to carry the information from an encoder to a decoder, allowing the decoder to reconstruct the original image or video. It shows particularly the “intra_TMP_flag” 1210 that is positioned at the coding unit level. When this flag is true, luma template matching prediction is to be performed for the current coding unit. In addition, the “intra_TMP_flag” 1220 signals the use of template matching prediction for the chroma, for both the Cb and Cr components.

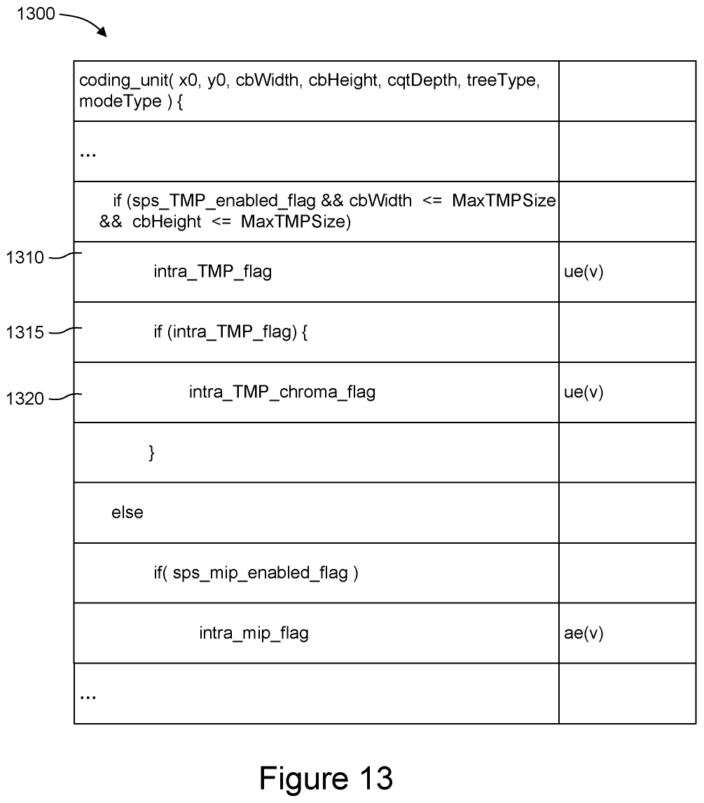

FIG. 13 illustrates a table of a second example of syntax signaling of luma and chroma template matching prediction according to at least one embodiment. The table 1300 only shows a subset of the conventional syntax required to carry the information from an encoder to a decoder, allowing the decoder to reconstruct the original image or video. It shows particularly the “intra_TMP_flag” 1310 that is positioned at the coding unit level. When this flag is true, luma template matching prediction is performed for the current coding unit. In addition, the “intra_TMP_flag” 1320 signals the use of template matching prediction for the chroma, for both the Cb and Cr components. However, contrasting with the syntax of FIG. 12, in this embodiment, the use of template matching prediction for the chroma is only signaled when template matching prediction is performed for the luma. This has both advantage of reducing the signaling of flags, and to make use of luma TMP search as in the embodiments of FIGS. 7B, 7C and 9B, 9C. That is, chroma TMP is performed after luma TMP using the same displacement vector.

In at least one embodiment, the luma template size can vary. The size of the luma template may be carried over signaling information.

In at least one embodiment, the luma template size is fixed as 4. In other words, the template is composed of 4 pixels above and/or left of the current block and reference block. The chroma template can use the same luma template size. However, it is usually argued that chroma coding is simpler than luma coding. For this, chroma template size can be set smaller than luma template size. For this reason, in at least one embodiment, luma and chroma template size is set to be independent. The size of the luma and chroma templates may be carried over signaling information.

The variations on the template size apply to any of the shape used for the template, such as rows above the block or columns at the left of the bock or both the rows above the block and the columns at the left of the bock.

In order to improve the coding performance when combining IntraTMP and IBC, at least one embodiment proposes to make use of chroma IntraTMP in the IBC candidate list. This is done as follows:
1. Determine the block vectors according to IntraTMP for all components (Y, Cb and Cr) for the current block,
2. Add the determined luma IntraTMP block vector to the list of IBC block vector predictors for luma,
3. Add the determined Cb IntraTMP block vector to the list of IBC block vector predictors for Cb,
4. Add the determined Cr IntraTMP block vector to the list of IBC block vector predictors for Cr.

Therefore, the block vector determined according to the Intra template matching techniques described above for the chroma components may be used for the Intra Block Copy, allowing therefore to have different block vectors for luma, Cb and Cr.

As for the regular IBC block vectors, it is possible to save the IntraTMP block vectors into the IBC HMVP list so that they can be used in a more long-term fashion. But, unlike the regular IBC block vectors, the IBC HMVP list should be able to save the IntraTMP block vectors for luma, Cb and Cr. In a variant, the IBC HMVP list should also be able to save an information indicating that the block vector comes from an IntraTMP block.

Furthermore, in at least one embodiment, a flag can be signaled at CU level to indicate whether different block vectors are used. That is, if the flag is 1, the above method is performed, otherwise, only luma IntraTMP is used for all the components (Luma, Cb, Cr). The encoder can then select the best configuration. In a variant embodiment, this flag can be signaled at the slice, picture or SPS level for a more high-level flexibility.

In order to reduce the complexity of the IBC_TM modes, as the block vectors coming from IntraTMP have already been refined through the Intra template search, it is possible to indicate in the IBC candidate list that it is an IntraTMP or refined block vector. In this case, in the IBC_TM modes, the refinement process for those candidates can be skipped.

At least one embodiment proposes to add a high-level flag (for example at SPS level) to enable chroma IntraTMP. This flag, for example named “sps_chroma_tmp_enabled_flag”, can be used to switch the chroma TMP on or off. It is up to the encoder to decide whether to use chroma IntraTMP depending on the characteristics of the sequence. The sps_chroma_tmp_enabled_flag flag can be coded only if sps_intraTMP_enabled_flag is on.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

At least one example of an embodiment can involve a device as described herein, wherein the device comprises one of a television, a television signal receiver, a set-top box, a gateway device, a mobile device, a cell phone, a tablet, a computer, a laptop, or other electronic device.

In general, another example of an embodiment can involve a bitstream or signal formatted to include syntax elements and picture information, wherein the syntax elements are produced, and the picture information is encoded by processing based on any one or more of the examples of embodiments of methods in accordance with the present disclosure.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

1-28. (canceled)

29. A method comprising, for a current block of picture information comprising a luma block and at least one chroma block:
determining a displacement vector based on a distance between a selected luma block and a current luma block;
determining Cb and Cr chroma refinement areas respectively in partially decoded Cb and Cr chroma picture information based on the displacement vector;
selecting a Cb chroma block by applying a template matching process in the Cb chroma refinement area;
selecting a Cr chroma block by applying a template matching prediction in the Cr chroma refinement area; and
determining a prediction block for the current block based on samples of the selected luma, Cb chroma and Cr chroma blocks.

30. The method of claim 29, wherein the selected luma block is selected in an area of partially decoded picture information based on a template matching process comprising a comparison of a template associated with the current block to at least one other template associated with at least one other block in an area of decoded picture information, wherein the template matching process is applied on luma components.

31. The method of claim 29, wherein the prediction block is determined by copying samples of the selected blocks.

32. The method of claim 29, further comprising decoding the current block based on the prediction block.

33. The method of claim 29, further comprising encoding the current block based on the prediction block in a data content, wherein the data content comprises information indicating to use a template matching prediction process for the current block.

34. The method of claim 29, further comprising encoding the current block, based on the prediction block, in a data content, wherein the data content comprises first information indicating to use a first template matching prediction process for the current luma block and second information indicating to use a second template matching prediction process for current chroma blocks.

35. The method of claim 34, wherein the second information is signaled only when the first information indicates to use template matching prediction process for the current luma block.

36. The method of claim 34, wherein the current block has a top and a left side, and wherein the template associated with the current block comprises a set of pixels forming a L-shape at the top and at the left side of the current block.

37. An apparatus comprising at least one processor configured to, for a current block of picture information comprising a luma block and at least one chroma block:
determine a displacement vector based on a distance between a selected luma block and a current luma block;
determine Cb and Cr chroma refinement areas respectively in partially decoded Cb and Cr chroma picture information based on the displacement vector;
select a Cb chroma block by applying a template matching process in the Cb chroma refinement area;
select a Cr chroma block by applying a template matching prediction in the Cr chroma refinement area; and
determine a prediction block for the current block based on samples of the selected luma, Cb chroma and Cr chroma blocks.

38. The apparatus of claim 37, wherein the selected luma block is selected in an area of partially decoded picture information based on a template matching process comprising a comparison of a template associated with the current block to at least one other template associated with at least one other block in an area of decoded picture information, wherein the template matching process is applied on luma components.

39. The apparatus of claim 37, wherein the prediction block is determined by copying samples of the selected blocks.

40. The apparatus of claim 37, further comprising decoding the current block based on the prediction block.

41. The apparatus of claim 37, further comprising encoding the current block, based on the prediction block, in a data content, wherein the data content comprises information indicating to use a template matching prediction process for the current block.

42. The apparatus of claim 37, further comprising encoding the current block, based on the prediction block, in a data content, wherein the data content comprises first information indicating to use a first template matching prediction process for the current luma block and second information indicating to use a second template matching prediction process for current chroma blocks.

43. The apparatus of claim 42, wherein the second information is signaled only in when the first information indicates to use template matching prediction process for the current luma block.

44. The apparatus of claim 42, wherein the current block has a top and a left side, and wherein the template associated with the current block comprises a set of pixels forming a L-shape at the top and at the left side of the current block.

45. The apparatus of claim 37, wherein the apparatus is one of a television, a television signal receiver, a set-top box, a gateway device, a mobile device, a cell phone, a tablet, a computer, a laptop, or other electronic device.

46. A non-transitory computer readable medium having stored instructions that, when executed by a processor, cause the processor to, for a current block of picture information comprising a luma block and at least one chroma block:
determine a displacement vector based on a distance between a selected luma block and a current luma block;
determine Cb and Cr chroma refinement areas respectively in partially decoded Cb and Cr chroma picture information based on the displacement vector;
select a Cb chroma block by applying a template matching process in the Cb chroma refinement area;
select a Cr chroma block by applying a template matching prediction in the Cr chroma refinement area; and
determine a prediction block for the current block based on samples of the selected luma, Cb chroma and Cr chroma blocks.

47. The non-transitory computer readable medium of claim 44, wherein the selected luma block is selected in an area of partially decoded picture information based on a template matching process comprising a comparison of a template associated with the current block to at least one other template associated with at least one other block in an area of decoded picture information, wherein the template matching process is applied on luma components.

48. The non-transitory computer readable medium of claim 46, wherein the prediction block is determined by copying samples of the selected blocks.
